(19) United States
(12) Patent Application Publication
(10) Pub. No.: US 2017/0364943 A1
(43) Pub. Date: Dec. 21, 2017

(54) MARKETING SYSTEM AND METHOD

(71) Applicant: Harbinger Enterprises, LLC, Blaine, WA (US)

(72) Inventor: Dorothy J. Berry, Blaine, WA (US)

(21) Appl. No.: 15/624,231

(22) Filed: Jun. 15, 2017

Related U.S. Application Data
(60) Provisional application No. 62/352,889, filed on Jun. 21, 2016.

(51) Int. Cl. G06Q 30/02; G09B 7/07

(52) U.S. Cl. CPC G06Q 30/0236; G09B 7/07

(57) ABSTRACT

A computer-implemented method for marketing a product of a partner includes generating a link that is unique to the partner; receiving a request, comprising the link, from a non-partner, wherein the non-partner receives a coding invitation from the partner, the coding invitation including the link; associating the non-partner with the partner based on the link in the request; receiving a coding from the non-partner; and saving the coding and providing a result of the coding to the partner and the non-partner.

### CROSS-REFERENCE TO RELATED APPLICATIONS

This application claims priority to U.S. provisional patent application Ser. No. 62/352,889 filed Jun. 21, 2016, and entitled “Marketing System and Method,” the disclosure of which is incorporated by reference.

### BACKGROUND

In one sense, sellers and buyers, marketers and consumers, producers and customers (collectively, human participants or parties) rely on some form of interaction to connect, share interests, and ultimately, consummate a transaction. In a first example, two parties may connect to consummate the sale of a product or service. In a second example, two participants may connect to share ideas and experiences. In an aspect of this second example, a first participant may desire to enlist multiple second participants to support a cause, a political candidate, or a charity. Broadly stated then, the connection is simply between suppliers and recipients, although the roles (i.e., supplier and recipient) of the two parties or participants may switch back and forth. Conventional advertising may facilitate this connection. Recently, targeted advertising has been used to more carefully match suppliers and recipients. More recently, Internet Web sites, such as go-fund-it sites, have been used to connect a first party (a recipient) with potential second parties (suppliers).

Current systems and methods do not account for certain objectively and subjectively quantifiable aspects of participants, such as different language interpretations or usages, or perceptions of the participants, for example. More specifically, different participants may communicate differently, and may think, feel, perceive, react, respond, need, and appreciate differently. Different participants may have vastly different value systems. When presented with an unpleasant situation, one participant may react objectively and another emotionally. These varying characteristics, personality traits, and sentiments, which may be driven by cultural and ethnic backgrounds, for example, can and often do affect the outcome of a transaction and yet are not considered in current systems.

### SUMMARY

A computer-implemented method for marketing a product of a partner includes generating a link that is unique to the partner; receiving a request, comprising the link, from a non-partner, wherein the non-partner receives a coding invitation from the partner, the coding invitation including the link; associating the non-partner with the partner based on the link in the request; receiving a coding from the non-partner; and saving the coding and providing a result of the coding to the partner and the non-partner.

A non-transitory, computer-readable storage medium having encoded thereon machine instructions that when executed by a processor, cause the processor to generate a link that is unique to the partner; receive a request, comprising the link, from a non-partner, wherein the non-partner receives a coding invitation from the partner, the coding invitation including the link; associate the non-partner with the partner based on the link in the request; receive a coding from the non-partner; and save the coding and providing a result of the coding to the partner and the non-partner.

A computer-implemented marketing method includes a processor receiving a partner registration and creating a partner-unique link and establishing a partner account; the processor receiving a request from a non-partner, the request including the partner-unique link; the processor providing a coding process for the non-partner; the processor receiving a coding from the non-partner; the processor saving the coding and providing the coding to the non-partner and the partner; and providing to the non-partner, a list of one or more partner products.

### DESCRIPTION OF THE DRAWINGS

The detailed description refers to the following figures in which like numerals refer to like items, and in which:

FIG. 1 illustrates a representative environment in which two or more parties may communicate;

FIG. 2 illustrates an example server system operated by one of the parties of FIG. 1;

FIGS. 3A and 3B illustrate examples of user interfaces generated by the server system of FIG. 2;

FIG. 3C illustrates an example product that may be displayed by or through the system of FIG. 2; and

FIGS. 4A and 4B illustrate a flow chart displaying an example operation executed by the server system of FIG. 2.

### DETAILED DESCRIPTION

For simplicity and illustrative purposes, the principles of the embodiments are described by referring mainly to examples thereof. In the following description, numerous specific details are set forth in order to provide a thorough understanding of the embodiments. However, one of ordinary skill in the art will appreciate that the embodiments may be practiced without limitation to these specific details. In some instances, well known methods and structures are not described in detail to avoid obscuring the embodiments.

In an embodiment, disclosed herein are systems and methods that allow parties to establish and use a communications framework based on information such as sentiments, values, and goals expressed by one or more of the parties. The systems may include one or more Web sites, applications, or other data and programming repositories. In an aspect, the systems may provide data and programming necessary to execute the methods in a “cloud storage” environment. In one aspect, the systems and methods enable and include, respectively, the process of acquiring a Total Assessment Personality Profile (TAPP™). The TAPP™ may be acquired by a “partner” from one or more “non-partners.” Both the partner and any non-partners may be considered system visitors, or Web site visitors, when the systems invoke use of a Web site. As an example of the process to obtain a TAPP™, a non-partner connects to an Internet Web site and is presented with four “virtual cards.” Each card has a list of values printed on it. The non-partner sorts the cards in order of importance as perceived by the non-partner, with the card that the non-partner believes contains the most important values placed first. The non-partner places all cards in order with the card the non-partner relates to the least being last. The herein disclosed system then evaluates the non-partner's card placement to determine the non-partner's TAPP™. When the non-partner completes this aspect of the process the non-partner is considered “coded.”

A partner may invite non-partners to be coded. The first step in inviting a non-partner to be coded is for the partner to create a unique custom link (UCL), i.e., a link that is unique to the partner. The partner then may use the UCL to invite non-partners to “code” themselves at, for example, a system Web site. When a non-partner uses the UCL to code himself, the system “knows” that the non-partner was directed to the system by the partner. That is, the system uses the partner's UCL to associate the partner with non-partners and other partners who use the UCL when interacting with the system and optionally when those non-parties and other partners use the UCL when interacting with systems operated by the partner. All subsequent activity of the non-partner on or through the system then may be credited and/or reported to the partner.

The partner may distribute the UCL in multiple ways including distributing the UCL from the partner's own server using an “Invite a Friend Program” provided by the system. With this method, the partner may enter the email addresses (or other address for another communications mechanism such as a text message or a social media communications mechanism) of non-partners to invite the non-partners into the system. The system then sends invites using the partner's UCL. Alternately, the partner may send an invite that includes the UCL from a system operated by the partner. The invited non-partners then can follow a link in the email (or through other communications mechanisms) to code themselves. This link may use, include, or reference the partner's UCL.

After coding, a non-partner may be presented with the corresponding TAPP™. After reviewing the TAPP™, the non-partner may be given an opportunity to view the partner's personal products (PPPs) online. A partner's personal product may be a product or service for sale, a go-fund-it page, an advertisement, or a petition, for example. The non-partner also may receive an email with a link to the non-partner's TAPP™. As noted herein, the email also may contain a link that the non-partner may follow to invite the non-partner's friends also to get coded. When those additional non-partners are coded, they may be associated with the original partner that invited the original non-partner through the original partner's UCL. This hierarchical process of non-partners inviting others may continue indefinitely with all coded non-partners in the hierarchy being associated with the original partner through the original partner's UCL.

Everyone (non-partner and partner) who is coded then becomes a potential customer for the original partner and their contact information automatically (i.e., without intervening actions required of the original partner or the non-partner or a subsequent partner) may be added, for example, to the partner's email marketing contact list. In addition, the original partner receives an email or other communication with the contact information and TAPP™ of the party (e.g., a non-partner) who was coded. The other communication may involve writing the contact information to an account of the partner, including an account maintained by the system or an account maintained by the partner or another entity.

The methods executed by the herein disclosed systems may involve use of information that in some respect identifies a device that a Web site visitor, including a non-partner, uses to access the Web site. For example, when a person uses an Internet browser to access a Web site, a Web server may create a random identification (ID) that identifies the browser and may cause the random ID to be stored on the Web site or in the browser.

In situations in which the systems disclosed herein collect personal information about Web site visitors, or may make use of personal information, the Web site visitors may be provided with an opportunity to control whether programs or features collect Web site visitor information (e.g., information about a Web site visitor's social network, social actions or activities, profession, a Web site visitor's preferences, or a Web site visitor's current location). In addition, certain data may be treated in one or more ways before it is stored or used, so that personally identifiable information is removed. For example, a Web site visitor's identity may be treated so that no personally identifiable information can be determined for the Web site visitor, or a Web site visitor's geographic location may be generalized where location information is obtained (such as to a city, ZIP code, or state level), so that a location of a Web site visitor cannot be determined. Thus, the Web site visitor controls how information is collected about the Web site visitor and used by the system.

In situations in which a partner uses an email address of a non-partner to send a UCL, the partner may have obtained permission from the non-partner to do so. In addition, the non-partner may be provided with an opt-out feature to terminate any further contact with the partner and the Web site.

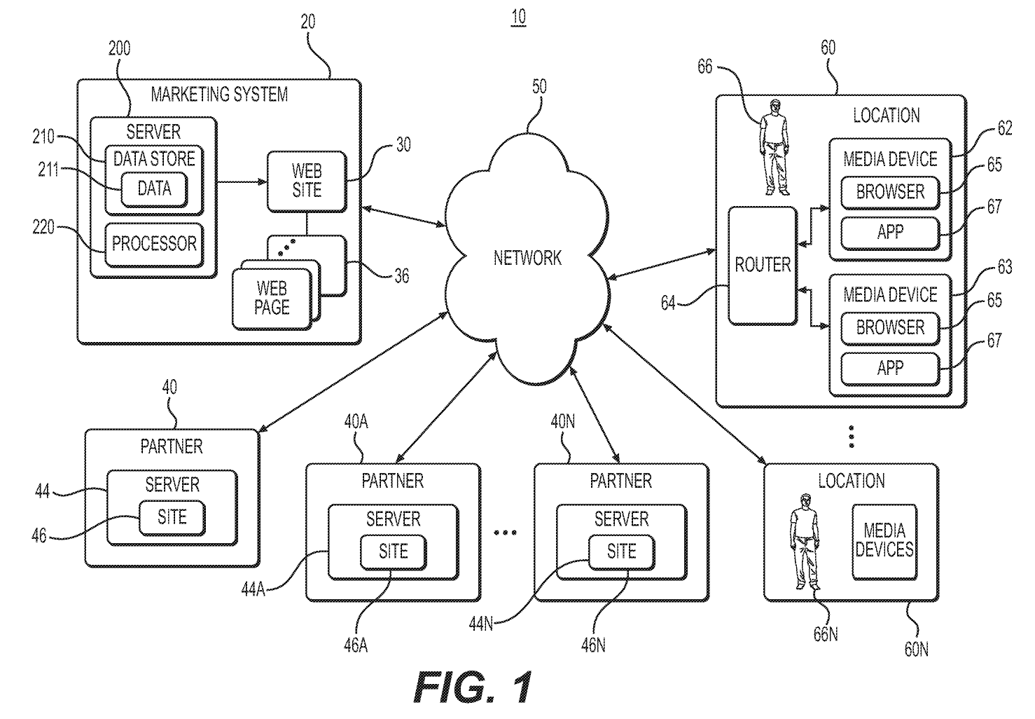

FIG. 1 illustrates a representative environment 10 including marketing system 20, partners 40-40N (partners 40i), and non-partners 66-66N at locations 60-60N. The various entities shown in FIG. 1 may communicate through communications network 50. In FIG. 1, a first party, referred to hereafter as partner 40 wishes to connect to one or more second parties, referred to hereafter as non-partner 66 or other partners 40A-40N. The partner 40 and non-partner 66 or another partner may be geographically dispersed.

Marketing system 20 includes server system 200, which in turn includes data store 210, which in turn includes database 211, and processor 220. The system 20 may communicate with other entities through Web site 30 and corresponding Web pages 36, by email, and by other means.

The partner 40 may be an individual person or an organization. The partner 40 accesses computer processing equipment, storage equipment, and communications equipment (e.g., server system 44) to communicate over network 50 with the non-partner 66 or other partners 40i. The server system 44 may generate Web site 46.

The non-partner 66 will, in general, be an individual person. In FIG. 1, a non-partner 66 may connect with the server systems 200 and 44 from viewing locations 60-60N.

The viewing location 60 may be a fixed location such as the residence of the non-partner 66 or may be a mobile location, such as in an automobile or at a retail store, for example. Whether at a fixed location such as a residence or a mobile location, such as an automobile, the non-partner 66 may operate media devices to access the system 20.

In an embodiment, the non-partner 66 operates media devices 62 and 63 to access, through router 64, resources such as Internet Web sites (e.g., sites 30 and 46). The media devices 62 and 63 may be fixed or mobile. For example, media device 62 may be an Internet connected “smart” television (iTV); a “basic” or “smart” television connected to a set top box (STB) or other Internet-enabled device; a Blu-Ray™ player; a game box; and a radio, for example. Media device 63 may be a tablet, a smartphone, a lap top computer, or a desk top computer, for example. The media devices 62 and 63 may include browsers, such as browser 65. The browser 65 may be a software application for retrieving, presenting, and traversing resources such as at a Web site. A resource may be identified by a Uniform Resource Locator (URL) and may be a Web page, image, video, or other content. The URL may allow the browser 65 to connect to a Web site. Hyperlinks present in resources enable the non-partner 66 to navigate the browser 65 to related resources. The non-partner 66 may operate the browser 65 to search for Web sites related to specific topics or to search for a specific Web site by URL. The media devices 62 and 63 also may include applications 67. The non-partner 66 may cause the media devices 62 or 63 to execute the application 67. The application 67 may involve use of means to connect to services provided through the system 20.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless. The network 50 may be all or a portion of an enterprise or secured network. In an example, the network 50 may be a virtual private network (VPN) between the partner 40 and a media device operated by the non-partner 66 across a wireline or a wireless link. While illustrated as a single or continuous network, the network 50 may be divided logically into various sub-nets or virtual networks, so long as at least a portion of the network 50 may facilitate communications among the entities of FIG. 1.

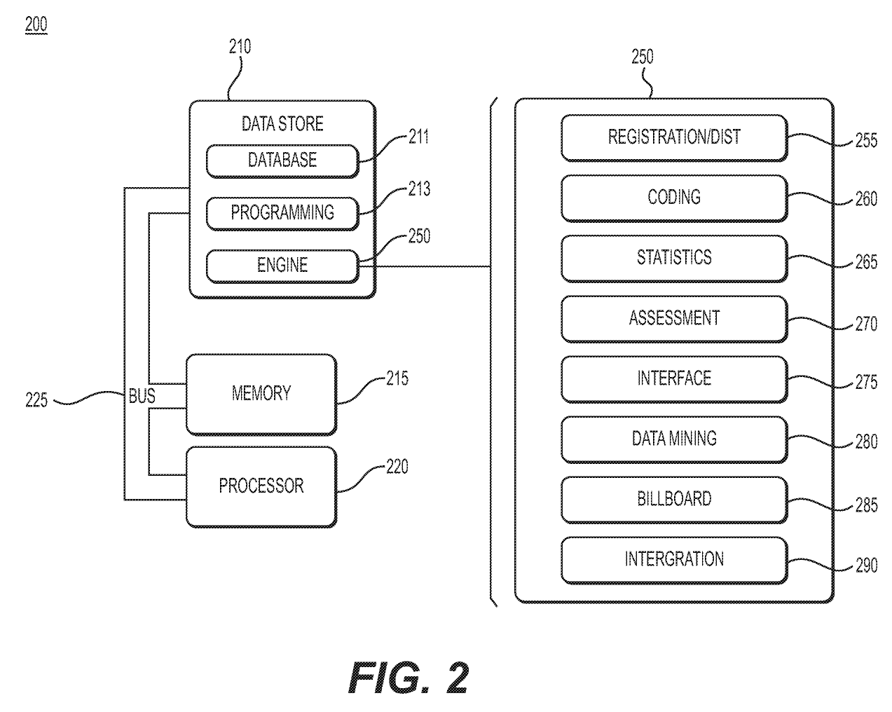

FIG. 2 illustrates the example server system 200 operated in the environment of FIG. 1 to provide enhanced marketing. The system 200 may be implemented on a suitable hardware platform. In an embodiment, the system 200 includes hardware components 201 such as data store 210, memory 215, processor 220, and communications bus 225. The data store 210, which includes non-transitory computer-readable storage mediums, provides database 211, programming 213, and marketing engine 250.

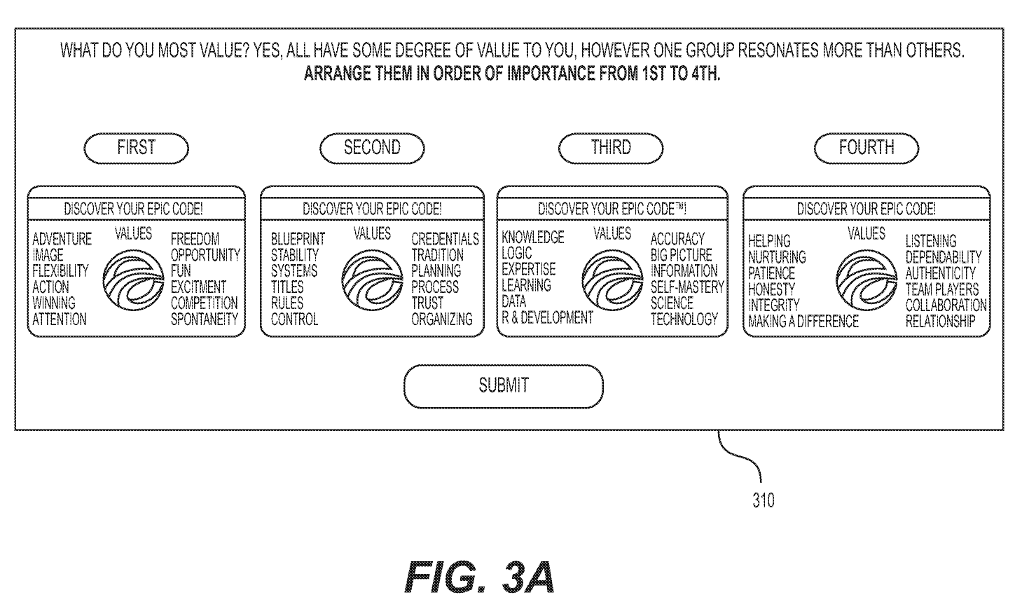

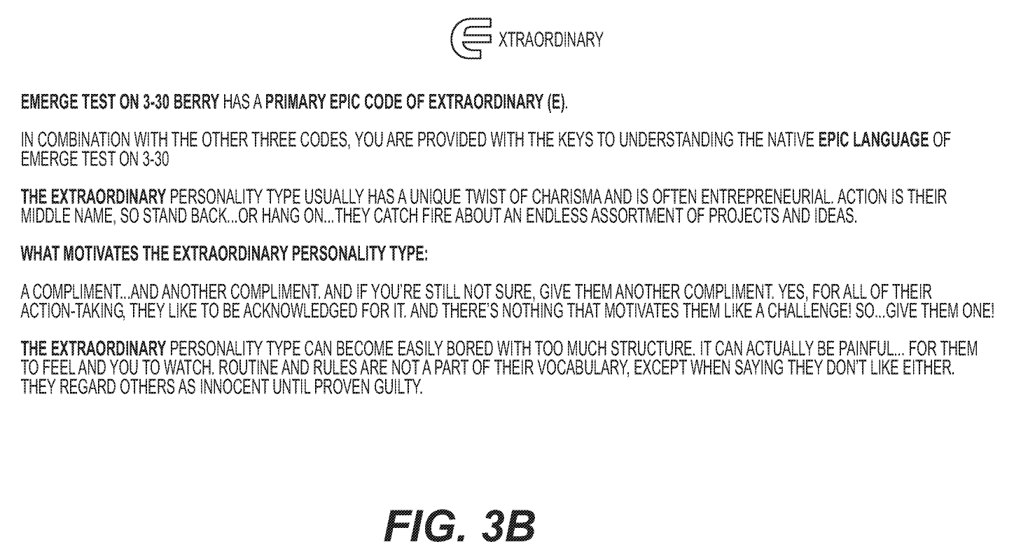

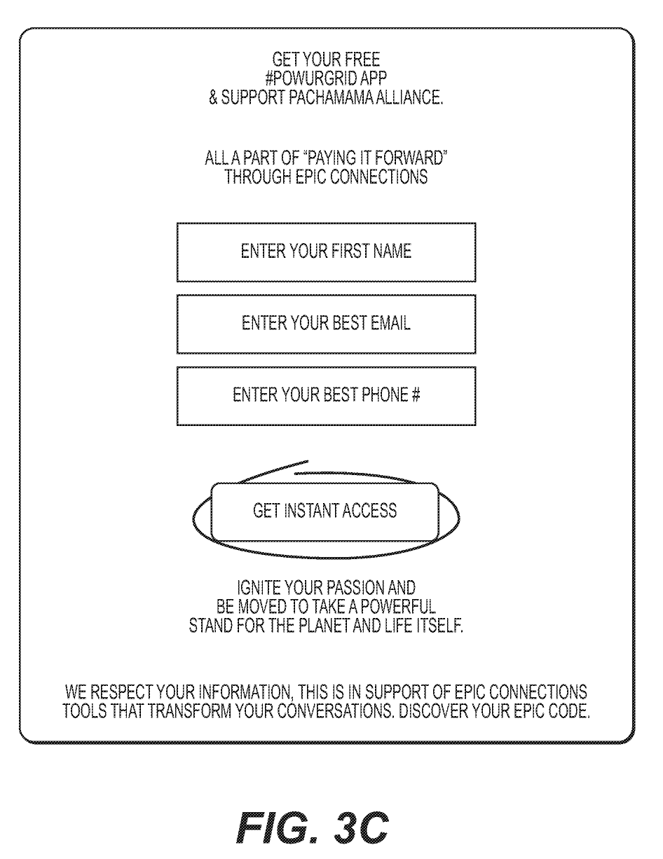

Data and coding from the database 211, programming 213, and marketing engine 250 may be accessed by processor 220, loaded into memory 215 over bus 225 and processed/executed by the processor 220. The processor 220 may generate a user interface (UI) through which various functions of the marketing engine 250 are made available to users, such as the partner 40 and the non-partner 66 shown in FIG. 1. For example, the UI may provide displays similar to those of FIGS. 3A-3B, and further may provide pull down menus, or other lists, of controls, commands, and features from which may select, and other features, windows, dialog boxes controls, and displays.

Through use of the system 20, and in particular the marketing engine 250, partners and non-partners may interact through partner personal products (PPPs) such as:
A direct email;
A direct text message or other form of short messaging;
A direct voice call;
Downloaded coupons and offers;
Downloaded brochures, literature, and information related to partners and the partner's products and services, including updates regarding provision of those products and services;
A link sent to a friend or other partner/non-partner;
A sign up for an email list;
A sign up for a consultation or appointment;
A sign up for a Webinar;
A video subscription;
Filling out surveys;
Posting a comment;
Purchase of products and/or services; and
Donations to an organization or cause.

In an embodiment, the marketing engine 250 includes registration/distribution module 255, coding module 260, statistics/reporting module 265, assessment module 270, user interface module 275, data mining module 280, billboard module 285, and integration module 290. The registration/distribution module 255 provides mechanisms that allow a party to register as a partner, including mechanisms to create a unique custom link (UCL), i.e., a link that is unique to the partner 40. The UCL may be used to invite non-partners 66 to “code” themselves at, for example, system Web site 30. When a non-partner 66 uses the UCL to code himself, the system 20 “knows” that the non-partner 66 was directed to the system 20 by the partner. That is, the system 20 reads the UCL, consults a database of UCLs and partners 40i, and identifies the partner 40i whose UCL was used in the coding process. As disclosed herein, the partner's UCL can be seen to persist among a hierarchy of non-partners 66 and other partners 40i as the non-partners 66 and other partners 40i access the system 20 with reference to the UCL. In this way, all the activity of the non-partner 66 on the system 20 then may be credited or reported to the partner 40. The module 250 also provides mechanisms by which the partner 40 may distribute the UCL. Such mechanisms allow the UCL to be distributed from the partner's own server such as the server 44. One example of these mechanisms is an “Invite a Friend” program” or applet provided by or through the system 20. In an aspect, the partner 40 may operate system 44 to send invitations. In another aspect, the partner 40 may, for example, enter the email addresses or other contact information, for example, of non-partners 66 to invite the non-partners 66 into the system 20. The system 20 then sends invites using the partner's UCL. In either aspect, the invited non-partners 66 then can follow a link in the email to code themselves, with the coding tied to the UCL.

The coding module 260 provides mechanisms that allow a non-partner 66 to obtain a Total Assessment Personality Profile (TAPP™). In an embodiment, a non-partner 66 connects to an Internet Web site 30 by clicking on the UCL and is presented with four “virtual cards.” Each virtual card has a list of values printed on it. In one aspect, each card provides a list of default values. In another aspect, the partner 40i who created the UCL and who invited the non-partner 66 may select from alternate lists of virtual cards or may create custom virtual cards that are unique to the partner 40i. In any of these aspects, the module 260 allows the non-partner 66 to sort the cards in order of importance to the non-partner 66, with the card that the non-partner 66 relates to the most being placed first and the card the non-partner 66 relates to the least being placed last.

Statistics/reporting module 265 includes mechanisms that gather information related to non-partner interactions (see examples of partner personal products (PPPs) above) tied to a specific partner 40i through the partner's UCL and, consolidates and reports that information to the partner 40i in a manner and to an address as designated by the partner 40i. Subsequent to the coding, the module 265 tracks and reports views and interactions by the non-partner 66 including interactions with the partner's PPPs.

The assessment module 270 includes mechanisms to evaluate a non-partner's card placement to determine the non-partner's TAPP™. When the non-partner 66 completes this aspect of the process the non-partner 66 is considered “coded.” The assessment module 270 also may report the TAPP™ to the non-partner 66 (for example, by email) and may display the TAPP™ on a user interface available to the non-partner 66.

The user interface module 275 provides mechanisms to generate the user interfaces (such as shown for example in FIGS. 3A-3B); the user interfaces allow both partners 40 and non-partners 66 to use the system 20. The user interfaces may be deployed on Web pages 36, through an application, or through other means.

The marketing engine 250 may, in an embodiment, rely on the non-partner's TAPP™ to provide information useful to the partner 40 to enhance interactions with the non-partner 66. In another embodiment, the marketing engine 250 includes optional data mining module 280. The optional data mining module 280 receives non-partner-entered data such as an email address or telephone number, or other information (e.g., entered through a Web page) that may serve as a starting point for searching publicly available information. The data mining module 280 also includes search features that search social media, Web 2.0 accounts, analytics sites, and other sites, and collects publicly available information, including, for example, images, mailing addresses, and business and professional information related to the non-partner 66. The module 280 further collects available demographic data, geographic location (using for example, the non-partner's IP address, browser language, and make and model of media device). The data mining module 280 may set a tracking cookie to record activities by the non-partner 66. The module 280 may create a non-partner account and may store the above-noted data in the file in database 211. The optional module 280 may add information to the TAPP™ using, for example, contact APIs and may update the TAPP™ based on subsequent interactions between the non-partner 66 and the partner's personal products. In addition, the module 280 determines referrer information (e.g., “invite a friend”) and associates the information gathered by the module 280 with the partner through the partner's UCL. Finally, the module 280 makes certain of the non-partner data available to a partner's corresponding services. For example, the non-partner's email address may be made available to the partner's email account; sale information may be made available to the partner's accounting services, etc.

The billboard module 285 provides mechanisms a partner may use to provide partner personal products (PPP) for viewing by non-partners. The module 285 may rely on feed URLs entered by a partner 40 and stored in a partner 40 account in the database 211. The PPPs selected by the partner may be integrated by the system 20 with the partner-designated feeds. As part of this process, the partner 40 may designate types of posts from feed that may appear with the PPPs. The feeds may be changed in real-time. The module 285 may include mechanisms that the partner may use to create one or more campaigns tied to the partners PPPs. For example, a partner may create a first campaign directed to the advertisement and sale of products and a second campaign directed to a charitable fundraising. The partner's UCL may apply to both campaigns but through the module 285, the partner may direct certain non-partners to the first campaign and other non-partners to the second campaign. Such a decision could be based on each non-partner's TAPP™. In another aspect, the partner may use the module 285 to direct different non-partners to different advertisements for the same product, based on the non-partner's TAPP™. As noted above, the statistics/reporting module 265 tracks and reports views and interactions including interactions with the PPPs.

The process of the module 285 is database driven. Partner accounts and associated PPP information are stored in database 211, and each partner is assigned a UCL. The UCL is associated with the partner 40 rather than any particular PPP. By having the UCL assigned in this manner, the partner 40 is free to add or change PPPs and still retain the ability to track interactions by non-partners 66.

FIGS. 3A and 3B illustrate examples of user interfaces generated by the server system of FIG. 2. FIG. 3A shows an example user interface 310 with four “virtual cards”, each of which specifies certain characteristics, values, or personality traits. A non-partner 66 is presented these four cards and asked to arrange the four cards in an order that represents the highest value set to that non-partner 66. FIG. 3B displays a summation of one TAPP™.

FIG. 3C illustrates an example partner personal product as displayed through the system 20.

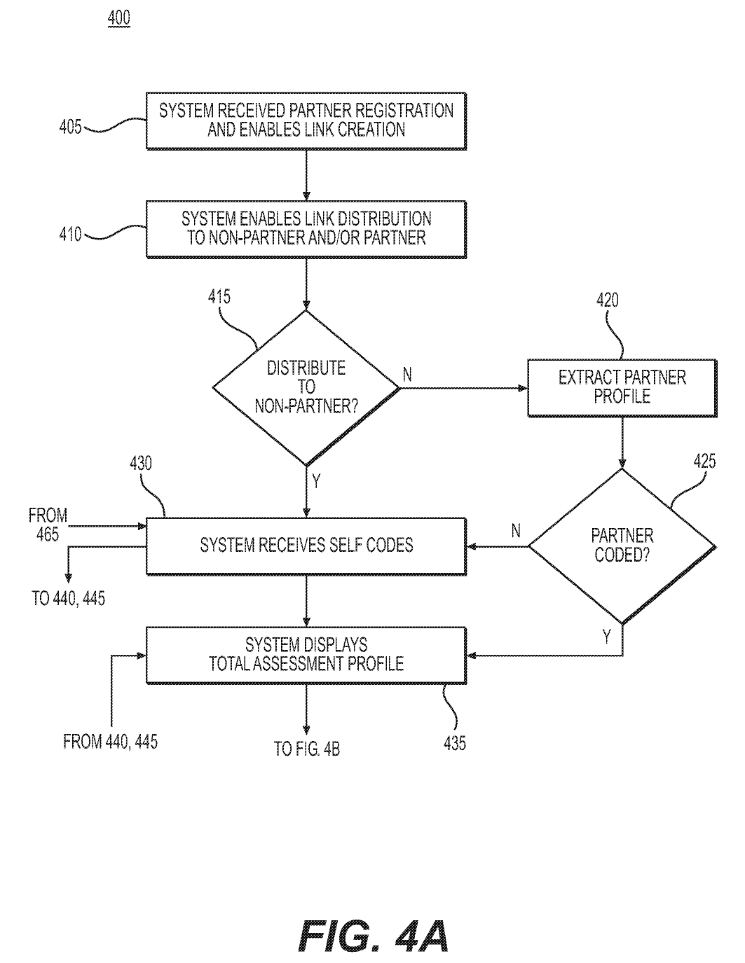

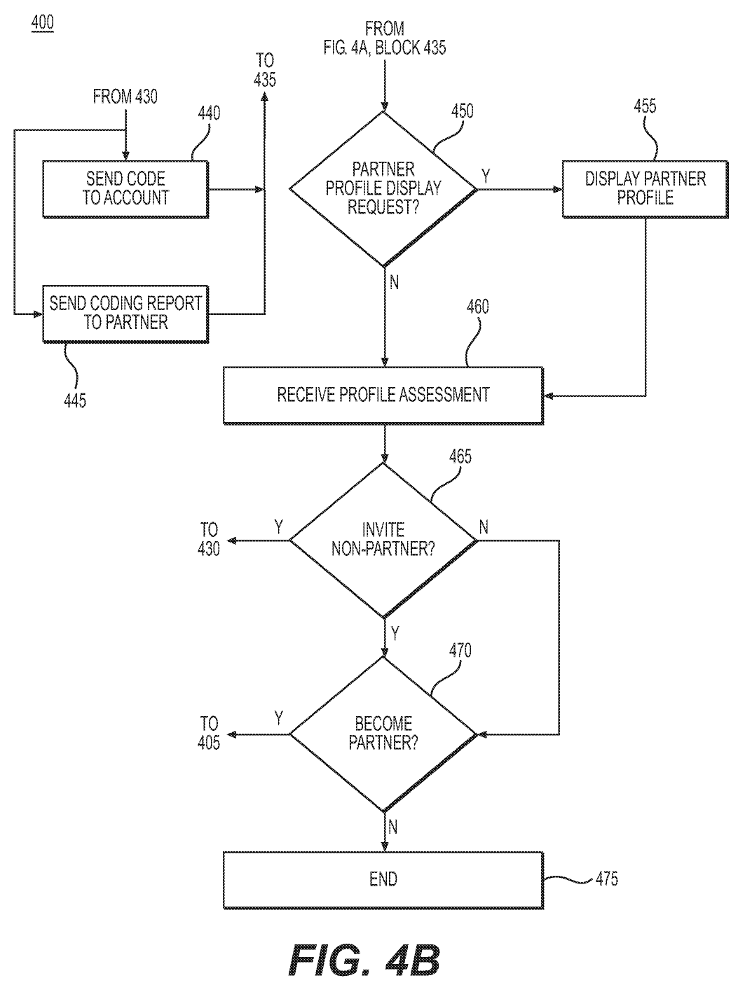

FIGS. 4A and 4B illustrate a flow chart displaying example method 400 executed by the system 20 of FIG. 1. The flow chart illustrating example method 400 shows various steps or processes executed in a specific sequence. However, not all steps or processes need be performed, and not all steps or processes need be performed in the sequence illustrated.

In FIG. 4A, method 400 begins in block 405 when system 20 receives a partner registration (e.g., from partner 40) and enables the partner 40 to create or upload a uniquely coded link (the UCL) and create a partner account or profile. The UCL then may be used to invite parties (either non-partners 66 or other partners 40i) to “code” themselves at Web site 36. The partner 40 also may register various accounts such as the partner's AWeber account, email account, or other accounts that may receive information or data from parties (e.g., non-partners) invited through the system 20 to access a partner's personal products. When a (for example) non-partner 66 uses the partner's UCL to code themselves, the system 20 “knows” that the non-partner 66 was directed to the system 20 by the partner 40. Subsequently, all activity of the non-partner 66 on the system 20 may be credited and reported to the partner 40.

Following the registration of block 405, the partner 40 may stop, save the registration, and exit the method 400, or continue to block 410. Alternately, following the link creation and registration of block 405, the method 400 may move to block 410, and the system 20 enables the partner 40 to distribute the link to one or more non-partners 66 and/or one or more partners 40i.

In block 415, the system 20 determines if the recipient of the distributed link is a partner or a non-partner. If the recipient is a partner, the method 400 moves to block 420 and the system 20 extracts the partner profile corresponding to the partner. The method 400 then moves to block 425 and the system 20 determines if the partner 40 is coded in the system 20. If the partner 40 is not coded, the method 400 moves to block 430. Otherwise, the method 400 moves to block 435.

In block 415, if the recipient is a non-partner 66, the method moves to block 430. In block 430, the system 20 receives the results of a non-partner coding operation (assuming the non-partner 66 performs the coding operation at the Web site 30) or a partner coding operation.

Following block 430, the method 400 then moves to block 435 and the system 20 displays the non-partner's total assessment personality profile (TAPP™) to the non-partner 66 using the Web site 30 (or a total personality profile for an invited partner). In addition, the system 20 may send, in block 440, the TAPP™ as well as, for example, the non-partner's contact information to an account (e.g., AWeber) as designated by the partner 40 and may send, in block 445, an email or other message to the partner 40 with the non-partner's coding information. Following the operations of blocks 440 and 445, the method 400 moves to block 450.

In block 450, the system 20 provides the non-partner 66 with an option to view the partner's personal product(s) and in response, the system 20 provides, block 455, a display of the partner's personal product(s). Note that a partner 40 may have several products; some or all the partner's personal products may be available for display to the non-partner 66. In an aspect, the partner 40 may arrange for display of a subset of products (including just one product) based on the coding operation of block 430. A partner's personal products may be displayed on a Web page 36 of the Web site 30 (see, for example, FIG. 3C) or through the partner's Web site 46. The non-partner 66 then may perform some action while viewing the partner's personal products. As an example, a partner's personal product may be a go-fund-it page (displayed for example on Web page 36 or on a Web page of the partner 40), and the non-partner 66 may contribute to the associated go fund it campaign directly from the Web page 36. Following block 455, or if the non-partner 66 elects not to view the partner's personal product(s) in block 450, the method 400 moves to block 460.

In block 460, the system 20 generates a personality profile for the non-partner 66 and sends the profile to the non-partner 66. One mechanism for sending the profile is through email.

Following receipt of the email, the non-partner 66 may invite a friend (possibly another non-partner 66) to be coded, block 465, with such coding linked to the UCL of the partner 40. If, in block 465, the non-partner 66 elects to invite a friend (e.g., another non-partner 66), the method 400 returns to block 430 and the method 400 moves to block 470, where the system 20 allows the non-partner 66 to become a partner 40i. In block 470, if the non-partner 66 elects to become a partner 40i, the method 400 returns to block 405. In block 470, if the non-partner 66 elects not to become a partner 40i, the method 400 moves to block 475 and ends.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing systems networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a flowchart and accompanying description to illustrate the embodiments represented in FIGS. 4A and 4B. The disclosed devices, components, and systems contemplate using or implementing any suitable technique for performing the steps illustrated. Thus, FIGS. 4A and 4B are for illustration purposes only and the described or similar steps may be performed at any appropriate time, including concurrently, individually, or in combination. In addition, many of the steps in the flow chart may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs; i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

1. A computer-implemented method for marketing a product of a partner, comprising the processor:
generating a link that is unique to the partner;
receiving a request, comprising the link, from a non-partner, wherein the non-partner receives a coding invitation from the partner, the coding invitation including the link;
associating the non-partner with the partner based on the link in the request;
receiving a coding from the non-partner; and
saving the coding and providing a result of the coding to the partner and the non-partner.

2. The method of claim 1, further comprising the processor executing a coding operation to create the coding, comprising:
displaying to the non-partner, a plurality of virtual cards, each virtual card comprising a set of personality values;
receiving an ordered arrangement of the plurality of virtual cards from the non-partner; and
computing a total assessment personality profile based on the ordered arrangement.

3. The method of claim 2, wherein providing the result of the coding to the non-partner comprises the processor:
displaying the total assessment personality profile to the non-partner using an electronic interface accessible by the non-partner; and
sending the total assessment personality profile to the non-partner in a message.

4. The method of claim 1, further comprising the processor:
providing a list of one or more partner personal products for viewing by the non-partner;
receiving a non-partner action related to one or more of the one or more personal products; and
associating the action with the partner based on the link.

5. The method of claim 4, further comprising the processor varying the partner personal products provided in the list of one or more partner personal products based on the non-partner's total assessment personality profile.

6. The method of claim 1, further comprising the processor:
receiving a second request, comprising the link, from a second non-partner, wherein the second non-partner receives a coding invitation from the non-partner, the coding invitation including the link;
associating the second non-partner with the partner based on the link in the second request;
receiving a second coding from the second non-partner; and
saving the second coding and providing a result of the second coding to the partner and the second non-partner.

7. The method of claim 6, further comprising the processor:
receiving contact information for the non-partner and second contact information for the second non-partner; and
providing the contact information and the second contact information to an account of the partner.

8. The method of claim 6, further comprising the processor:
providing the non-partner and the second non-partner an option to register as a partner;
receiving a request from the non-partner to register as a partner;
generating a unique second link for the non-partner, thereby designating the non-partner as a second partner; and
maintaining an association of the second partner to the partner.

9. The method of claim 8, further comprising the processor:
receiving a third request, comprising the second link, from a third non-partner, wherein the third non-partner receives a coding invitation from the second partner, the coding invitation including the second link;
associating the third non-partner with the second partner based on the second link in the third request;
receiving a coding from the third non-partner; and
saving the coding and providing a result of the coding to the second partner and the third non-partner.

10. A non-transitory, computer-readable storage medium having encoded thereon machine instructions that when executed by a processor, cause the processor to:
generate a link that is unique to the partner;
receive a request, comprising the link, from a non-partner, wherein the non-partner receives a coding invitation from the partner, the coding invitation including the link;
associate the non-partner with the partner based on the link in the request;
receive a coding from the non-partner; and
save the coding and providing a result of the coding to the partner and the non-partner.

11. The non-transitory, computer-readable storage medium of claim 10, wherein the processor executes a coding operation to create the coding, comprising:
displaying to the non-partner, a plurality of virtual cards, each virtual card comprising a set of personality values;
receiving an ordered arrangement of the plurality of virtual cards from the non-partner; and
computing a total assessment personality profile based on the ordered arrangement.

12. The non-transitory, computer-readable storage medium of claim 11, wherein providing the result of the coding to the non-partner comprises the processor:
displaying the total assessment personality profile to the non-partner using an electronic interface accessible by the non-partner; and
sending the total assessment personality profile to the non-partner in a message.

13. The non-transitory, computer-readable storage medium of claim 10, further comprising the processor:
providing a list of one or more partner personal products for viewing by the non-partner;
receiving a non-partner action related to one or more of the one or more personal products; and
associating the action with the partner based on the link

14. The non-transitory, computer-readable storage medium of claim 13, further comprising the processor varying the partner personal products provided in the list of one or more partner personal products based on the non-partner's total assessment personality profile.

15. The non-transitory, computer-readable storage medium of claim 13, further comprising the processor:
receiving a second request, comprising the link, from a second non-partner, wherein the second non-partner receives a coding invitation from the non-partner, the coding invitation including the link;
associating the second non-partner with the partner based on the link in the second request;
receiving a second coding from the second non-partner; and
saving the second coding and providing a result of the second coding to the partner and the second non-partner.

16. The non-transitory, computer-readable storage medium of claim 15, further comprising the processor:
receiving contact information for the non-partner and second contact information for the second non-partner; and
providing the contact information and the second contact information to an account of the partner.

17. The non-transitory, computer-readable storage medium of claim 15, further comprising the processor:
providing the non-partner and the second non-partner an option to register as a partner;
receiving a request from the non-partner to register as a partner;
generating a unique second link for the non-partner, thereby designating the non-partner as a second partner; and
maintaining an association of the second partner to the partner.

18. A computer-implemented marketing method, comprising:
a processor receiving a partner registration and creating a partner-unique link and establishing a partner account;
the processor receiving a request from a non-partner, the request including the partner-unique link;
the processor providing a coding process for the non-partner;
the processor receiving a coding from the non-partner;
the processor saving the coding and providing the coding to the non-partner and the partner;
the processor generating an association between the partner and the non-partner based on the partner-unique link; and
the processor providing to the non-partner, a list of one or more partner products.

19. The method of claim 18, further comprising:
providing the non-partner an option to register as a partner;
receiving a request from the non-partner to register as a partner;
generating a second unique link for the non-partner, thereby designating the non-partner as a second partner; and
maintaining the association between the second partner to the partner.

20. The method of claim 18, further comprising:
receiving a non-partner action related to one or more of the one or more personal products; and
associating the action with the partner based on the link.
